(19) United States
(12) Patent Application Publication
(10) Pub. No.: US 2017/0006395 A1
(43) Pub. Date: Jan. 5, 2017

(54) BENDABLE MICROPHONE

(71) Applicant: MOTOROLA SOLUTIONS, INC., Schaumburg, IL (US)

(72) Inventors: Chooi Heng Loo, Bayan Lepas (MY); Yin Hsian Koh, Bayan Lepas (MY); Kok Khian Ng, Butterworth (MY); Cheah Heng Tan, Bayan Lepas (MY)

(21) Appl. No.: 14/755,133

(22) Filed: Jun. 30, 2015

(51) Int. Cl. H04R 29/00; H04R 1/08; H04R 1/04

(52) U.S. Cl. CPC H04R 29/004; H04R 1/04; H04R 1/083

(57) ABSTRACT

A bendable boom microphone. In one embodiment, the bendable boom microphone includes a bendable boom, a microphone, a sensor, and a controller. The bendable boom has a first end and a second end opposite the first end. The first end of the bendable boom is anchored. The microphone is positioned at the second end of the bendable boom. The sensor detects a bend angle of the bendable boom. The controller receives an indication of the bend angle from the sensor and operates the bendable boom microphone in one of a plurality of modes based on the bend angle.

### BACKGROUND OF THE INVENTION

To control various functions in a headset (or earset) with a boom microphone a user may need to push a button, slide a switch, or otherwise mechanically manipulate a similar control on the headset. For example, muting a microphone or initially activating a voice-operated switch (e.g., a voice operated exchange (Vox)), may require a user to access a button on the headset associated with the particular function. Mechanical manipulation of such a button can be difficult, and takes time as the user needs to search for the particular button associated with the desired function. These difficulties can be exacerbated in the dark (especially if the button is not backlit or does not protrude), or when the radio is inserted into the pocket, or when the user is riding a motorcycle.

In some devices (for example, a mobile radio), the user may need to navigate through a system menu in order to mute/unmute the microphone. Navigating through such a menu usually takes a longer amount of time to accomplish that actuated a button or similar control.

Accordingly, there is a need to find a convenient way to mute/unmute the microphone or activate/deactivate other functions (i.e., a Vox feature) in order to enhance a user's experience with a mobile communications device.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an illustration of a person wearing a headset incorporating a bendable boom microphone in accordance with some embodiments.

FIG. 2 is the illustration of FIG. 1 showing axes of a two-dimensional plane in which the bendable boom microphone can be bent.

FIGS. 3A through 3C are diagrams showing a bendable boom microphone at various bend angles (0 degrees, 30 degrees, and 60 degrees are shown in the figures).

FIG. 4 is a block diagram of a bendable boom microphone in accordance with some embodiments.

FIG. 5 is a graph of a resistance of an exemplary resistance based flexible bend sensor.

FIG. 6 is a flow chart showing the operation of a bendable boom microphone in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One embodiment provides a bendable boom microphone. The bendable boom microphone includes a bendable boom, a microphone, a sensor, and a controller. The bendable boom has a first end and a second end opposite the first end. The first end of the bendable boom is anchored. The microphone is positioned at the second end of the bendable boom. The sensor detects a bend angle of the bendable boom. The controller receives an indication of the bend angle from the sensor and operates the bendable boom microphone in one of a plurality of modes based on the bend angle.

Another embodiment provides a method of operating a bendable boom microphone. The method includes the steps of detecting a bend angle of a bendable boom of the bendable boom microphone, comparing, by a controller, the bend angle to a first threshold, operating the bendable boom microphone in a first operating mode when the bend angle is less than the first threshold, and operating the bendable boom microphone in a second operating mode when the bend angle is greater than the first threshold.

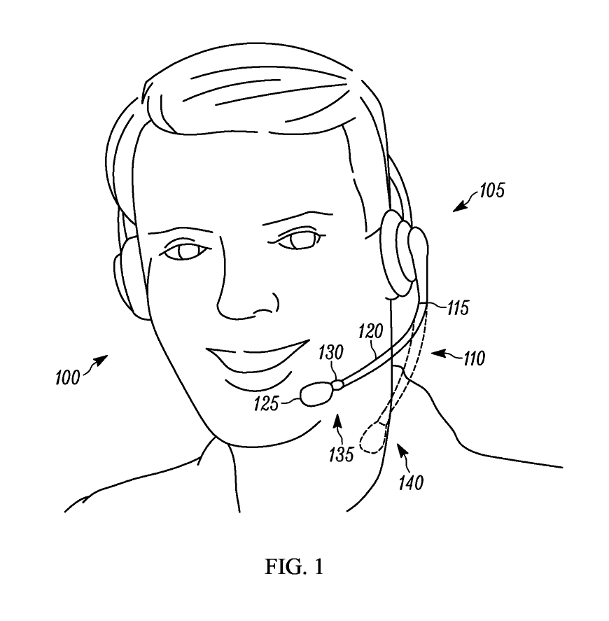

FIG. 1 shows a person 100 wearing a headset 105. The headset 105 includes a boom microphone 110. The boom microphone 110 has an anchor 115, a bendable boom 120, and a microphone 125. In some embodiments, the boom microphone 110 includes an indicator 130 (e.g., a light emitting diode (LED)). As shown in FIG. 1, the boom microphone 110 can be bent in a plane such that the boom microphone 110 moves between a plurality of positions including a first position 135 and a second position 140.

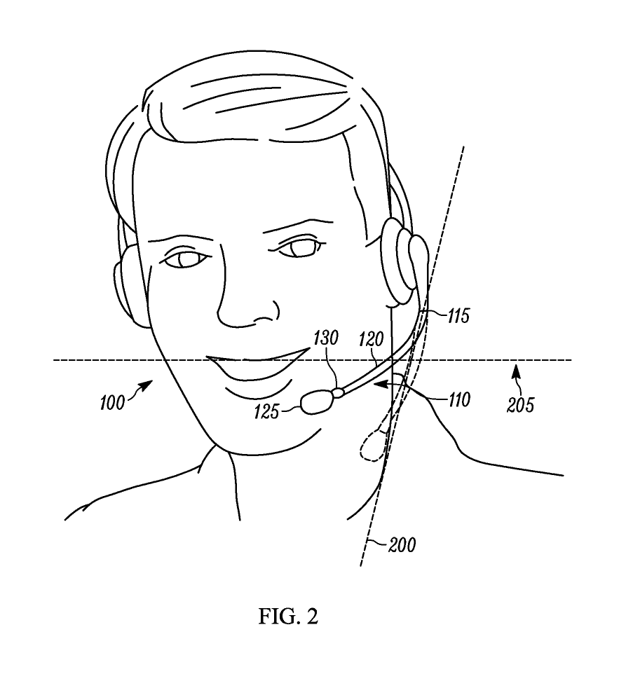

As shown in FIG. 2, the boom microphone 110 can be bent in a two-dimensional plane defined by a first axis 200 and a second axis 205. The first axis 200 is defined by a line that extends through the bendable boom 120 when the bendable boom 120 is straight (i.e., not bent). The second axis 205 is defined by a line that extends parallel with the mouth 210 of the person 100 through a point on the bendable boom 120 when the bendable boom 120 is straight

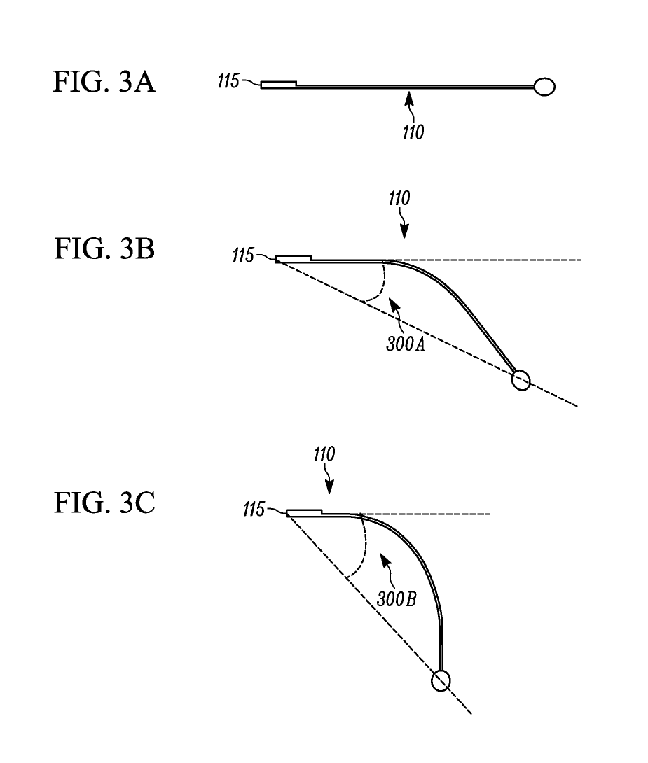

FIGS. 3A, 3B, and 3C show the boom microphone 110 in a straight position (FIG. 3A), a first bent position having a bend angle 300A of ˜30 degrees)(FIG. 3B), and a second bent position having a bend angle 300B of ˜60 degrees)(FIG. 3C). The bend angles shown in FIGS. 3A, 3B, and 3C are examples. Any number and size of bend angles are within the scope of the invention.

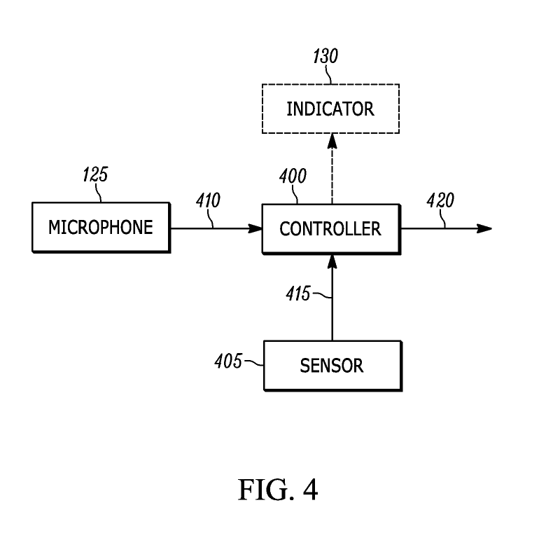

FIG. 4 is a block diagram of a boom microphone 110 according to one embodiment. The boom microphone 110 includes the microphone 125, a controller 400, a sensor 405, and an optional indicator 130. The microphone 125 detects sound and sends a signal 410 indicative of the sound to the controller 400. The sensor 405 detects the amount of bend in the bendable boom 120 of the boom microphone 110 and sends a signal 415 indicative of the amount of bend (i.e., the bend angle 300) to the controller 400. The controller 400 receives the indication and controls an operating mode of the boom microphone 110 based on the bend angle. The controller 400 also outputs, under certain conditions, an audio signal 420.

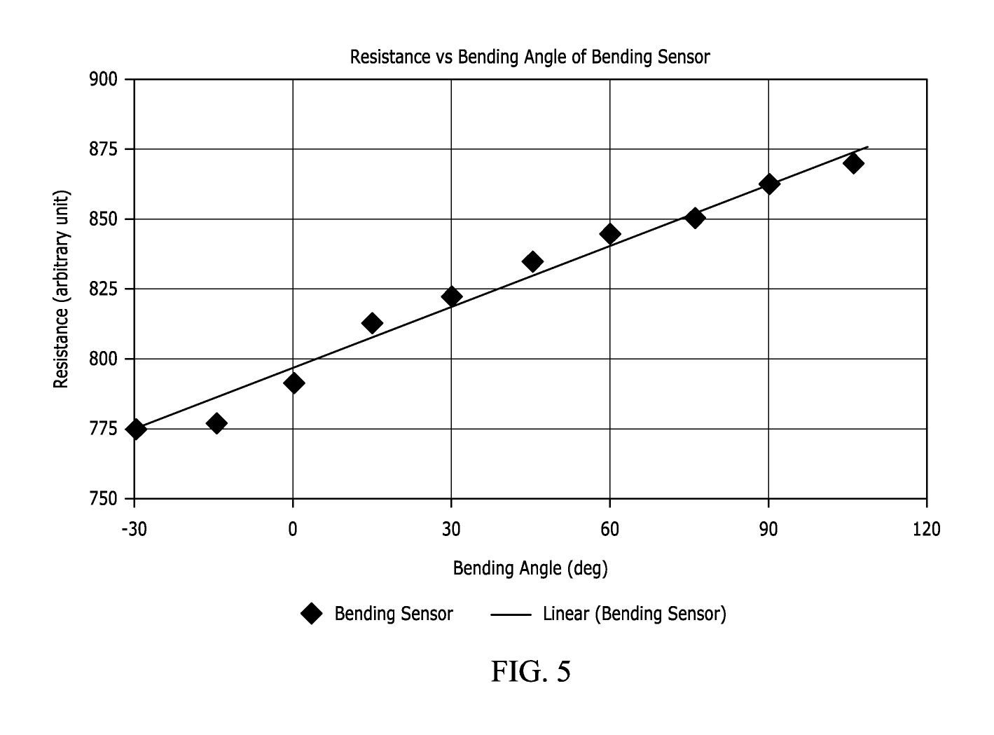

In one embodiment, the sensor 405 is a resistance-based, flexible bend sensor. The sensor 405 is attached to the bendable boom 120 and changes resistance as the boom is bent. FIG. 5 is a graph of the resistance of an example resistance-based, flexible bend sensor for various bend angles of the bendable boom 120. For example, the resistance of the sensor is about 825 ohms when the boom has a 30 degrees bend angle and about 850 ohms when the boom has a 60 degrees bend angle. The invention contemplates other types of sensors which can detect the angle the boom is bent in the plane and provide a signal to the controller 400 (e.g., piezoelectric) from which the controller 400 can determine the bend angle of the bendable boom 120.

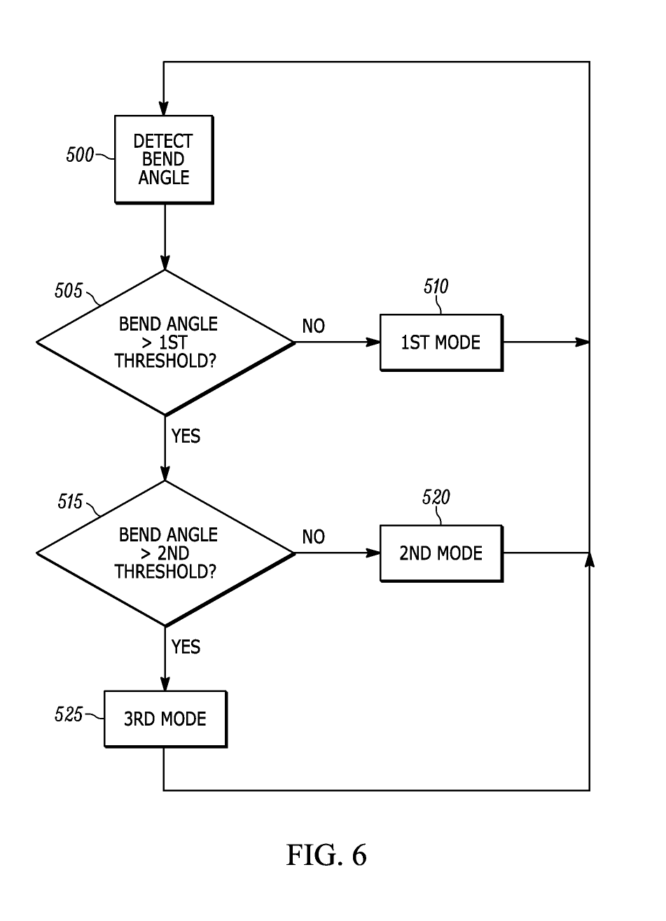

FIG. 6 is a flow diagram of an embodiment of the operation of the controller 400. The controller 400 obtains data from the sensor 405 and determines the angle of the bendable boom 120 (step 500). The controller 400 then compares the angle of the bendable boom 120 to a first threshold (e.g., 25 degrees) (step 505). If the angle of the bendable boom 120 is less than the first threshold, the controller 400 operates in a first mode (e.g., mutes or turns off the microphone 125; i.e., does not output the audio signal 420) (step 510).

If the bend angle 300 is greater than the first threshold, the controller 400 compares the bend angle to a second threshold (e.g., 45 degrees) (step 515). If the bend angle 300 is less than the second threshold, the controller 400 operates in a second mode (step 520).

If the bend angle 300 is greater than the second threshold, the controller 400 operates in a third mode (step 525).

Each of the modes can include one or more operations including mute/unmute, Voice Operated Exchange (VOX), adjusting sensitivity levels, noise canceling, answer/hang-up, etc. For example, in the embodiment of FIG. 6, the first mode can be mute/shut-off, the second mode can be unmute and set a first level of sensitivity, and the third mode can be set a second level of sensitivity and enter a VOX mode. In most embodiments, it is understood that as the bendable boom 120 is bent from one threshold level to the next (or from a higher bend angle threshold to a lesser bend angle threshold) that the previous mode is modified. Using the example, when the bendable boom 120 is moved from an angle greater than the second threshold to an angle between the first and second thresholds, the VOX mode is exited and the first level of sensitivity is implemented again. However, in other embodiments, the transitioning of mode as the bend angle is decreased may not mimic the reverse of the implementation of modes as the bend angle was decreased. Using the previous example, once the bend angle exceeds the second threshold, the VOX mode may be maintained until the bend angle is less than the first threshold.

The mode can also include providing an indication to the user of the functioning of the boom microphone 110. For example a sound or voice indication (i.e., an audio indication) can be provided to alert the user to which function the boom microphone 110 has switched to as the bendable boom 120 is bent. Other indications include lighting an LED (e.g., on/off, or different colors can be used for different functions) and a haptic indicator (e.g., vibrating the headset 105 when the boom microphone 110 switches from mute to unmute).

Although certain examples are explained in detail, embodiments may be implemented using a number of other thresholds and operations (e.g., one threshold only—determining on/off). Further, the controller 400 can continuously modify an operation (e.g., signal to noise ratio, sensitivity, volume, etc.) over the full range of bend angles (i.e., an analog operating mode).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter

1. A bendable boom microphone comprising:
a bendable boom having a first end and a second end, the second end opposite the first end, the first end anchored;
a microphone positioned at the second end of the bendable boom;
a sensor attached to the bendable boom for detecting a bend angle of the bendable boom; and
a controller receiving an indication of the bend angle from the sensor and operating the bendable boom microphone in one of a plurality of modes based on the bend angle;
wherein the bendable boom is bendable in a two-dimensional plane having an axis parallel to a user's mouth.

2. The bendable boom microphone of claim 1, wherein the controller operates the bendable boom microphone in a first mode when the bend angle is less than a first threshold.

3. The bendable boom microphone of claim 2, wherein the controller operates the bendable boom microphone in a second mode when the bend angle is greater than the first threshold.

4. The bendable boom microphone of claim 3, wherein the controller operates the bendable boom microphone in the second mode when the bend angle is greater than the first threshold and less than a second threshold.

5. The bendable boom microphone of claim 4, wherein the controller operates the bendable boom microphone in a third mode when the bend angle is greater than the second threshold.

6. The bendable boom microphone of claim 1, wherein the plurality of modes includes a mute operation and an unmute operation.

7. The bendable boom microphone of claim 1, wherein the plurality of modes includes a voice operated exchange operation.

8. The bendable boom microphone of claim 1, wherein the plurality of modes includes a setting a sensitivity level.

9. The bendable boom microphone of claim 1, wherein the plurality of modes includes a noise canceling operation.

10. The bendable boom microphone of claim 1, further comprising an indicator, the indicator providing an indication of which of the plurality of modes the bendable boom microphone is operating in.

11. The bendable boom microphone of claim 10, wherein the indicator is a light emitting diode.

12. The bendable boom microphone of claim 10, wherein the indicator is an audio indicator.

13. (canceled)

14. The bendable boom microphone of claim 1, wherein one or more operations of the bendable boom microphone are modified continuously over a full range of bend angles of the bendable boom.

15. A method of operating a bendable boom microphone, the method comprising:
detecting, by a sensor attached to the bendable boom, a bend angle of a bendable boom of the bendable boom microphone;
receiving, by a controller, an indication of the bend angle from the sensor; and
operating the bendable boom microphone in one of a plurality of modes based on the bend angle;
wherein the bendable boom is bendable in a two-dimensional plane having an axis parallel to a user's mouth.

16. The method of claim 15, further comprising
comparing, by the controller, the bend angle to a first threshold; and
operating the bendable boom microphone in a first operating mode when the bend angle is less than the first threshold; and
operating the bendable boom microphone in a second operating mode when the bend angle is greater than the first threshold.

17. The method of claim 16, further comprising operating the bendable boom microphone in the second mode when the bend angle is greater than the first threshold and less than a second threshold.

18. The method of claim 17, further comprising operating the bendable boom microphone in a third mode when the bend angle is greater than the second threshold.
